(19) United States
(12) Patent Application Publication
(10) Pub. No.: US 2006/0282956 A1
(43) Pub. Date: Dec. 21, 2006

(54) Combination carpet row separator and seam cutter

(76) Inventor: Patrick Underwood, El Cajon, CA (US)

Correspondence Address: Karl M. Steins;Steins & Associates, Suite 120, 2333 Camino del Rio South, San Diego, CA, 92108, US

(21) Appl. No.: 11/154,001

(22) Filed: Jun. 16, 2005

(51) Int. Cl. A47G 27/04; B26B 29/00

(52) U.S. Cl. 7/103; 30/294

(57) ABSTRACT

A Combination Carpet Row Separator and Seam Cutter is disclosed. The separator and cutter tool enables a skilled installer to accurately separate the carpet between rows and simultaneously make a high precision cut along the separated row. To improve performance, there is both a front ridge for guiding the tool along the separated row, as well as a rear ridge to prevent the tool's tendency to “fishtail.” To improve performance even more, the tool has a separator tip element extending into the carpet row ahead of the front ridge to create a more definite split in the carpet along the row. To accommodate a variety of carpet types, the device provides separator tip elements in both pointed and chisel-tipped profiles. For convenience, the device has a spare blade receptacle formed within the housing to hold spare blades. Finally, the device may have a laser guide associated with it to provide additional alignment assistance to the carpet installer while cutting patterned carpets.

### BACKGROUND OF THE INVENTION

1. Field of the Invention

This invention relates generally to flooring installation tools and equipment and, more specifically, to a Combination Carpet Row Separator and Seam Cutter.

2. Description of Related Art

Installation of carpeting is best handled by seasoned professionals due to the labor-intensive nature of the work, and the drastic defects that are likely to occur in the finished carpeting if all things are not done properly. One particularly important step in the installation of carpeting is cutting the bulk material to size. At the perimeter edges of the room, the carpet is essentially cut to fit. The more complicated cuts occur in the field of the carpeted room (i.e. in the middle of the floor, etc.). Since the rolled carpet is not always wide or long enough to reach all four walls in a room or group of rooms, the installer must many times splice two pieces of carpet together. While the installer will typically try to avoid high visibility locations or high traffic areas for the splices, it still will be apparent if a bad splice is made.

A splice is where two adjoining sections of carpet are sewn and/or taped together. If either side of the splice has a crooked or badly cut edge, the two pieces will not come together cleanly and the splice will be very noticeable and unsightly, and will probably not wear well. This is particularly true in patterned or textured carpeting. The goal in making clean cuts is to avoid cutting the pile of the carpeting (since this would leave “frizzy” ends). The way that this is achieved is to cut in between two “rows” of the carpet. A “row” is the basic structure of a carpet; it is where the yarn is looped through the backing of the carpeting.

Conventionally, the installer would use two separate tools to cut the carpet: a row separator for creating a visible spread between two rows in the carpet, and a carpet cutter. The problem with using two separate devices are many. First, by the time the installer has run the row separator down the length of the carpet to be cut, the spread between the rows can begin to close up again, before the cut can be made. Second, the conventional row spreader does not always track very well down the gap between rows—particularly when dealing with carpets that have complex patterns or color schemes. Finally, with two separate devices, the installer is required to constantly be picking up and putting down tools as the cut is being made.

What is needed, therefore, is a combination carpet row separator and seam cutter that provides improved row tracking as compared to the conventional devices.

### SUMMARY OF THE INVENTION

In light of the aforementioned problems associated with the prior devices, it is an object of the present invention to provide a Combination Carpet Row Separator and Seam Cutter. The separator and cutter tool should enable a skilled installer to accurately separate the carpet between rows and simultaneously make a high precision cut along the separated row. To improve performance, there should be both a front ridge for guiding the tool along the separated row, as well as a rear ridge to prevent the tool's tendency to “fishtail.” To improve performance even more, the tool should have a separator tip element extending into the carpet row ahead of the front ridge to create a more definite split in the carpet along the row. To accommodate a variety of carpet types, the device should provide separator tip elements in both pointed and chisel-tipped profiles. For convenience, the device should have a spare blade receptacle formed within the housing to hold spare blades. Finally, the device should have a laser guide associated with it to provide additional alignment assistance to the carpet installer while cutting patterned carpets.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a preferred embodiment of the carpet row separator and seam cutter of the present invention;

FIG. 2 is another perspective view of the device of FIG. 1;

FIG. 3 is a side view of the device of FIGS. 1 and 2;

FIG. 4 is a top view of a cutter blade of the device of FIGS. 1-3; and

FIG. 5 is a partial cutaway front view of the lower housing of the device of FIGS. 1-3.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Combination Carpet Row Separator and Seam Cutter.

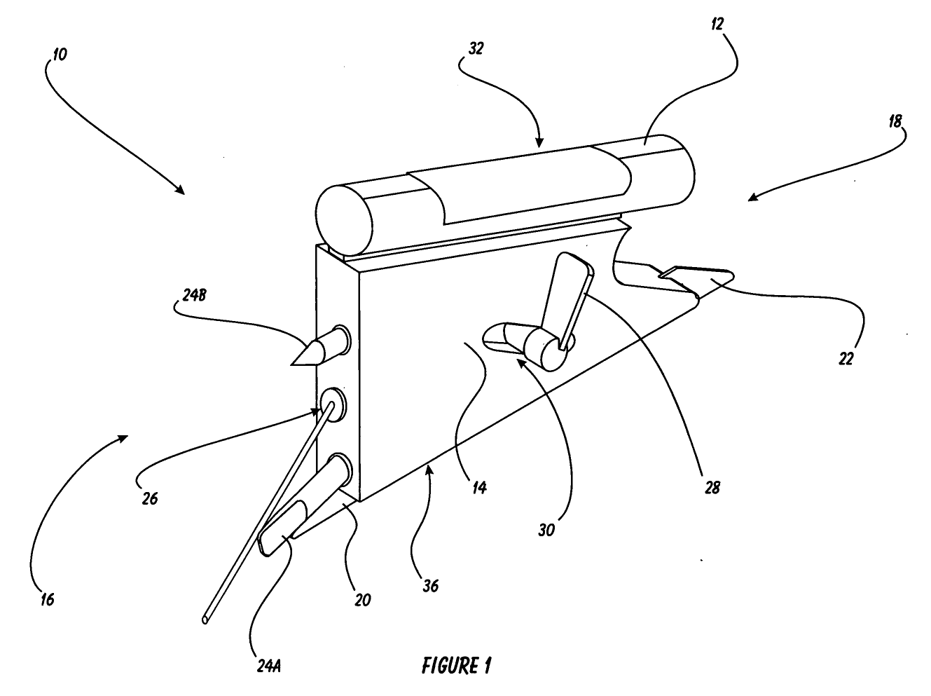

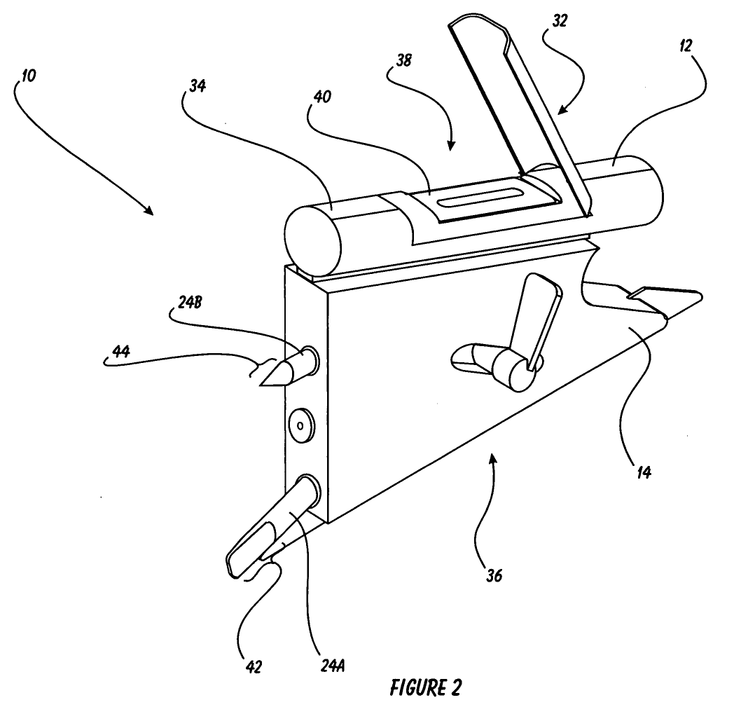

The present invention can best be understood by initial consideration of FIG. 1. FIG. 1 is a perspective view of the carpet row separator and seam cutter 10 of the present invention. The carpet row separator and seam cutter 10 is designed to perform the functions of two conventional devices: a row separator for splitting the pile of the carpet (and holding it spread apart), and a carpet cutter for cutting the carpet between the split pile. The cutter 10 comprises an upper housing 12 and a lower housing 14. The upper housing 12 is preferably ergonomically shaped to perform the function as a comfortable handle for grasping the device 10 when cutting carpet. The upper housing 12 is defined by a lid 32 formed in its top surface for storing spare cutting blades, as will be depicted below in connection with FIG. 2.

The lower housing 14 is defined by a front end 16, a tail end 18, and a bottom surface 36. A front ridge 20 extends forwardly and downwardly from the front end 16 of the lower housing 14. The front ridge 16 is a smooth (typically metallic) element that splits the pile of the carpet when the device 10 is placed onto the carpet and then slid forward along the carpet (along the carpet row).

The tail end 18 has a tail ridge 22 extending backwardly and downwardly (below the bottom surface 36) from the lower housing 14. The tail ridge 22 is designed to force the device 10 to continue to track along the separated (and now cut) row as the device is sent up the carpet row. By tracking along the row, the tail ridge 22 will prevent the device 10 from “fishtailing,” and thereby improve the quality and straightness of the cut in the carpet.

The front end 16 of the lower housing 14 has a first separator tip element 24A and a second separator tip element 24B extending forwardly therefrom. The two tip elements 24A and 24B can be removed and swapped with one another, depending upon the type of carpet being cut. In this depiction, the first separator tip element 24A is in the operable position, meaning that it will function to create the first row split as the device 10 is passed over the carpet. As such, the second separator tip 24B, in this depiction, is in a storage position. As should be apparent for the arrangement of the elements of the device 10, as the device 10 is passed along the surface of the carpet, the first separator tip element 24A will split the pile, preferably along a row of the carpet. The front ridge 20 will then keep the split in the row from closing. Next, the blade (not shown) will cut the carpet in between the pile. Finally, the tail ridge 22 will track along the cut in the carpet to prevent fishtailing as the cut is continued.

Some carpets display a distinct dye pattern. In these situations, it is critical not only to cut along the row of the carpet, but also to make sure that the pattern is cut at the same place on both halves of the carpet at the seam. In order to aid in the installer's ability to track the dye pattern, a laser guide 26 is provided on the front end 16 of the device 10. The laser guide 26 provides to long-range lighted line on the carpet surface that the installer can align the guiding tip (24A) to the dye pattern.

A slot 30 is cut into the side wall of the lower housing 14. The slot 30 provides side access to the operational cutting blade housed within the lower housing 14. The blade knob 28 (could be a lever-like structure as shown) can be tightened or loosened to adjust the height of the blade (not shown). If we now turn to FIG. 2, we can continue to examine the device of this impressive invention.

FIG. 2 is another perspective view of the device 10 of FIG. 1. The lid 32 is hinged to the top surface 34 of the upper housing 12. When flipped open, the lid 32 provides access to spare blades 40 stored within the blade storage compartment 38 provided within the upper housing 12.

Also shown here are the structural differences between the first tip element 24A and the second tip element 24B. The first tip element 24A has a chisel-shaped tip 42 at its leading end. The second tip element 24B has a pencil-shaped tip 44 at its leading end. In other versions, a single tip element 24A may have a pencil-shaped tip at one end and a chisel-shaped tip at the opposing end. A chisel-shaped tip is best used when separating the row of carpeting having a looped pile (e.g. berber carpet). A pencil-shaped tip is best for cut-pile carpet (i.e. plush carpet). Turning to FIG. 3, we can examine additional details of the invention.

FIG. 3 is a side view of the device 10 of FIGS. 1 and 2. Here, the tip of the blade 40 can be seen protruding from the bottom surface 36 of the lower housing 14. As shown, the front ridge 20 extends from just behind the first tip element 24A to just in front of the blade 40. As a result of this design, the device 10 is very easy to keep on track in the carpet row during a cutting operation. As discussed above, the height of the blade 40 can be adjusted as necessary (i.e. for different carpet thicknesses) by operation of the blade adjustment knob 28.

The first tip element 24A resides within a first tip socket 46A formed in the lower housing 14. The second tip element 24B is held within a second tip socket 46B. As discussed above, the tip elements 24A and 24B removed from their respective sockets 46A and 46B and exchanged, depending upon the type of carpet pile being cut.

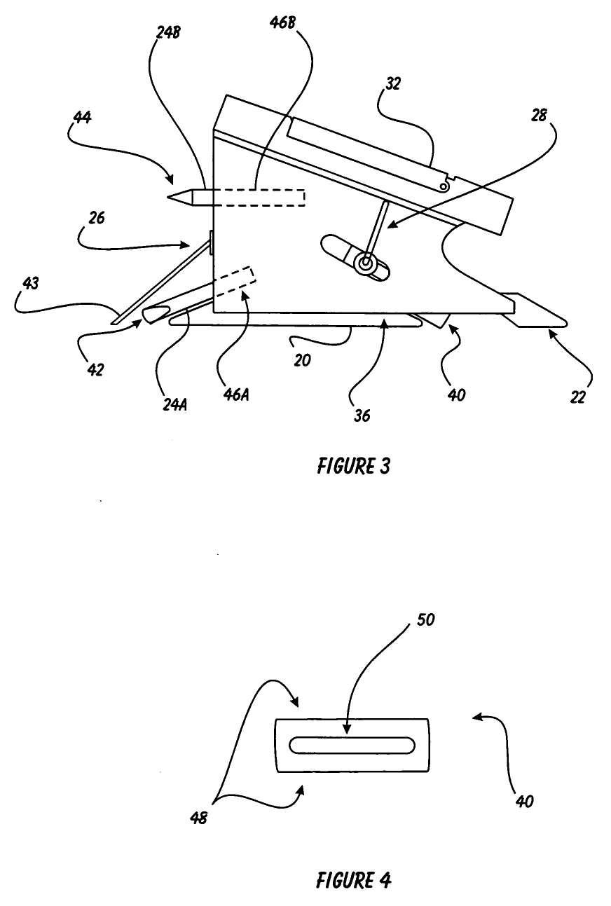

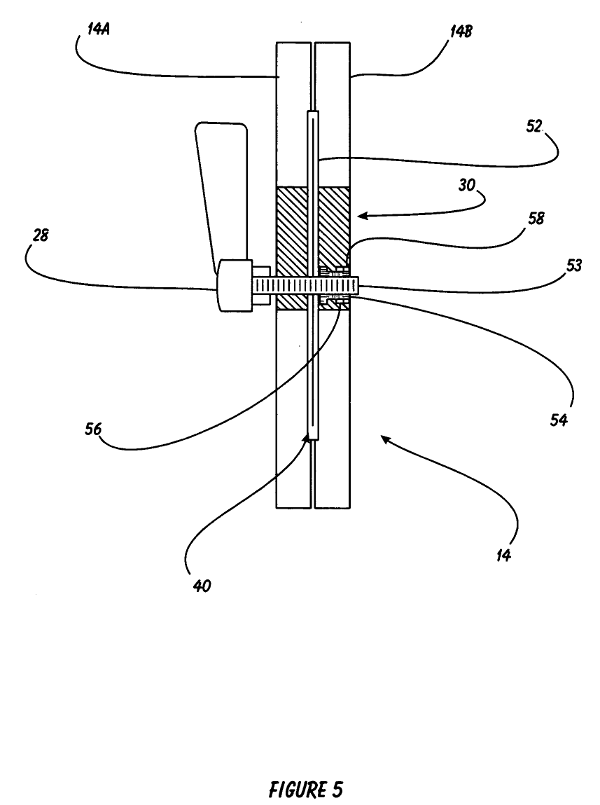

Also depicted here is the beam 43 created by the laser guide 26. The laser beam 43 may be simply a dot positioned at a desirable distance in front of the device 10, or it may be a line extending forward from the device 10. Furthermore, the angular positioning of the beam 43 may be adjustable for operator convenience. FIG. 4 shows what the blade 40 looks like. It is, essentially, an elongated double-edged razor blade. There is a slot 50 running along much of its length to cooperate with the blade adjustment knob 28 to raise or lower the amount that the blade 40 extends from the bottom surface 36 of the lower housing 14. There are two cutting edges 48, one on each opposing edge of the blade 40, so that the blade 40 can be flipped over when the first-used cutting edge 48 becomes dull. Finally, we will turn to FIG. 5 to examine the operational structure of the blade adjustment mechanism.

FIG. 5 is a partial cutaway front view of the lower housing 14 of the device of FIGS. 1-3. The lower housing 14 comprises a left-hand housing half 14A and a right-hand housing half 14B. When joined together, a blade cavity 52 is formed between the two halves 14A and 14B. The slot 30 is shown in diagonal cross-hatching in this view.

The blade adjustment knob 28 is threadedly engaged (or possibly permanently bonded to) a threaded shaft 53. The threaded shaft 53 extends through the slot 30 from one side to the other. It threads into a threaded bore formed within a clamp bushing 54 on the right-hand side of the blade 40. The clamp bushing 54 is prevented from falling out of the housing 14 when the knob 28 has been removed (such as for blade replacement) by a retaining ring 58. The spring washer 56 pushes against the housing 14 and the retaining ring 58. This forces the clamp away from the blade cavity 52. which aids in the changing of the blade by keeping the bushing 54 out of the way.

In order to adjust the blade 40 height, the user need simply partially unscrew the knob 28, which will loosen the clamping force between the clamp bushing 54 and the blade 40. The threaded shaft 53 will then be free to slide along the slot 30. Also, the slot formed in the blade (see FIG. 4) will enable the blade 40 to slide along the threaded shaft 53 for additional adjustability.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A carpet cutting device, comprising:
a housing;
a front ridge extending downwardly from said housing, said front ridge defining a leading edge and a trailing edge;
a blade extending downwardly from said housing, generally adjacent to said front ridge; and
a tail ridge extending downwardly from said housing adjacent to said blade, whereby said blade is bounded on a leading edge by said front ridge and bounded on a trailing edge by said tail ridge.

2. The device of claim 1, further comprising a first separator tip element defining a shaft terminating in a tip, said tip positioned adjacent to said leading edge of said front ridge.

3. The device of claim 2, wherein said first separator tip element is removably held within a first socket formed in said housing.

4. The device of claim 3, wherein said housing further comprises a second socket and a second said separator tip element removably held in said second socket.

5. The device of claim 4, wherein said tip of said first separator tip element is chisel-shaped.

6. The device of claim 5, wherein said second separator tip element is further defined by shaft terminating in a tip, said tip of said second separator tip element being conically-shaped.

7. The device of claim 6, wherein said housing further comprises a lid hingably attached to a top surface thereof, said housing further comprising a blade storage receptacle juxtaposed under said lid.

8. The device of claim 7, further comprising a laser guide associated with a front face of said housing.

9. The device of claim 8, wherein said housing further comprises a slot formed in a sidewall of said housing, said device further comprising a blade adjustment knob from which a threaded shaft extends through said slot to engage a blade residing within a blade cavity formed within said housing.

10. A carpet row separator and cutting device, comprising
a housing comprising a left half and a right half, said housing defined by top, bottom, front, tail and opposing side surfaces;
a front ridge extending downwardly from said bottom surface, said front ridge defining a leading edge, a bottom edge, and a trailing edge;
a blade extending downwardly from said bottom surface, generally adjacent to said front ridge trailing edge; and
a tail ridge extending downwardly from said housing adjacent to said blade, on a side opposite said front ridge.

11. The device of claim 10, wherein said housing further comprises a lid hingably attached to a top surface thereof, said housing further comprising a blade storage receptacle formed in said housing juxtaposed under said lid.

12. The device of claim 11, further comprising a laser light emitting device associated with said front surface.

13. The device of claim 12, wherein said housing further comprises first and second sockets formed in said housing and accessible through said front surface.

14. The device of claim 13, further comprising a first separator tip element defining a shaft terminating in a tip, said tip positioned adjacent to said leading edge of said front ridge, said shaft removably positioned in said first socket.

15. The device of claim 14, further comprising a second separator tip element defining a shaft terminating in a tip, said tip positioned adjacent to said leading edge of said front ridge, said shaft removably positioned in said second socket.

16. The device of claim 15, wherein said tip of said first separator tip element is chisel-shaped.

17. The device of claim 16, wherein said tip of said second separator tip element is conically-shaped.

18. The device of claim 17, wherein said housing further comprises a slot formed in a sidewall of said housing, said device further comprising a blade adjustment knob from which a threaded shaft extends through said slot to engage a blade residing within a blade cavity formed within said housing.

19. The device of claim 18, wherein a said slot is formed in said right half and in said left half.
